(19) United States
(12) Patent Application Publication
(10) Pub. No.: US 2014/0342312 A1
(43) Pub. Date: Nov. 20, 2014

(54) DENTAL INSTRUMENT

(71) Applicant: James TAYLOR, (US)

(72) Inventor: James Taylor, Leeds (GB)

(21) Appl. No.: 14/359,681

(22) PCT Filed: Nov. 19, 2012
(86) PCT No.: PCT/GB2012/052863

§ 371 Date: May 21, 2014

(30) Foreign Application Priority Data
Nov. 22, 2011 (GB) 1120123.3

(51) Int. Cl. A61C 5/04

(52) U.S. Cl. CPC A61C 5/04
USPC 433/141

(57) ABSTRACT

A dental instrument for hand use comprising a handle and a tool head, the tool head has a plurality of tools projecting from a flared end section having a width that increases away from the handle.

The present invention relates to dental instruments for hand use by a dentist, for example when installing fillings in teeth.

### BACKGROUND

Pliable filling material, such as amalgam material comprising a mixture of silver alloy and mercury, or resin-based materials, are typically applied to teeth, packed, burnished and shaped using separate dental instruments, which are passed to the dentist in turn by an assistant. Conventional dental instruments have a handle with a tool head having a single tool section at an end of the handle. Conventional dental instruments are designed for re-use, being manufactured from metal to withstand intensive cleaning.

To simplify use, multi-functional dental instruments have been proposed, in which the tool head has a plurality of tools, and/or the dental instrument has a tool at each end of the handle. A first known design provides a long tool head that has a serial arrangement of tools. A second known design provides a tool head having a branched arrangement of tools, in which three elongate tools project from an end of a dental instrument's handle with an approximately tetrahedral geometry. With the second design, a dentist can change between tools by rotation of the dental instrument about its handle.

Both conventional dental instruments and known multi-functional dental instruments have dental tool heads that require to be manufactured from high strength material to support the substantial forces arise during use. Examples of multi-functional dental instruments are shown in U.S. Pat. No. 4,643,677 and U.S.20050100860.

Conventional dental instruments have elongate handles, commonly having a generally cylindrical shape or a uniform polyhedral cross-section.

A used dental instrument presents a bio-hazard both to dental workers and to waste disposal workers. If the intensive cleaning facilities necessary to enable re-use are not available, the dental instrument requires careful disposal into a suitable receptacle. However, since metal instruments are unsuitable for disposal by shredding, they would typically require disposal into a bio-hazardous waste collection bin, but due to their length and shape they typically would not pack efficiently into such a bin. However, metal dental instruments may be expensive to manufacture, and so unattractive for disposable use.

### SUMMARY OF THE DISCLOSURE

According to an aspect of the present invention, there is provided a dental instrument for hand use comprising a handle and a tool head, the tool head has a plurality of tools projecting from a flared end section having a width that increases away from the handle.

The flared end section may have edges that increase in separation supra-linearly with increasing distance from the handle.

The cross-section of the flared end section may have side walls with concave exterior surfaces.

The exterior cross-section of the flared end section may be generally polygonal.

The exterior cross-section of the flared end section may be generally triangular.

The flared end section may be hollow, having an internal cavity.

The cavity may be open-ended, having an opening at an opposite end from the handle.

The width of the cavity may increase away from the handle.

The side walls of the flared end section may comprise one or more apertures into the internal cavity.

The cross-section of the flared end section may have side walls with convex interior surfaces.

The dental instrument may comprise an elongate handle having a waist portion connecting between adjacent handle sections, wherein

the waist portion is less resistant to deformation by bending and/or snapping than the adjacent handle sections between which the waist portion connects, when contra-rotational torques about torque axes transverse to the length of the handle are applied to the handle sections.

The waist portion may have a narrower minimum width than the minimum width of proximal ends of the adjacent handle sections.

The waist portion may be within the central half of the length of the handle.

The waist portion may be within the central third of the length of the handle.

The waist portion may be within the central quarter of the length of the handle.

The adjacent handle sections may taper such that their ends remote from the waist portion are narrower than their ends proximate the waist portion.

The adjacent handle sections may have a generally triangular cross-sectional shape.

The adjacent handle sections may be provided with a plurality of ribs running along their length.

The dental instrument may comprise a tool head at each end of the handle.

The dental instrument may be formed from a plastics material.

The dental instrument may be formed from a material suitable for shredding.

The dental instrument may be formed from a metal material, such as stainless steel or aluminium.

### BRIEF DESCRIPTION OF THE DRAWINGS

Embodiments of the invention are further described hereinafter with reference to the accompanying drawings, in which:

FIG. 1A shows a perspective view of a dental instrument according to the present invention;

FIGS. 1B and 1C show side views the dental instrument of FIG. 1A;

FIG. 2A shows a perspective view of a tool head of the dental instrument of FIG. 1A;

FIG. 2B shows an end view of the tool head of FIG. 2A;

FIG. 2C shows a side view of a tool head of FIG. 2A; and

FIG. 3 shows a side view of the middle portion of the handle of the dental instrument of FIG. 1A.

### DETAILED DESCRIPTION

Like reference numerals refer to like elements throughout.

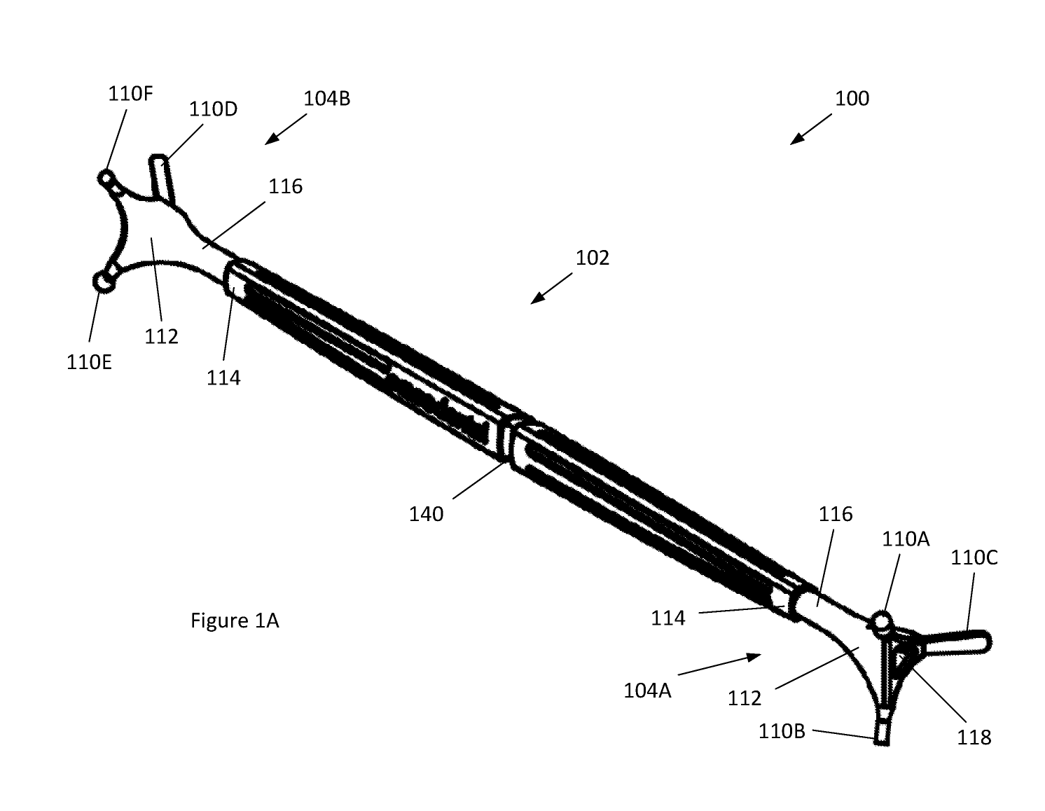

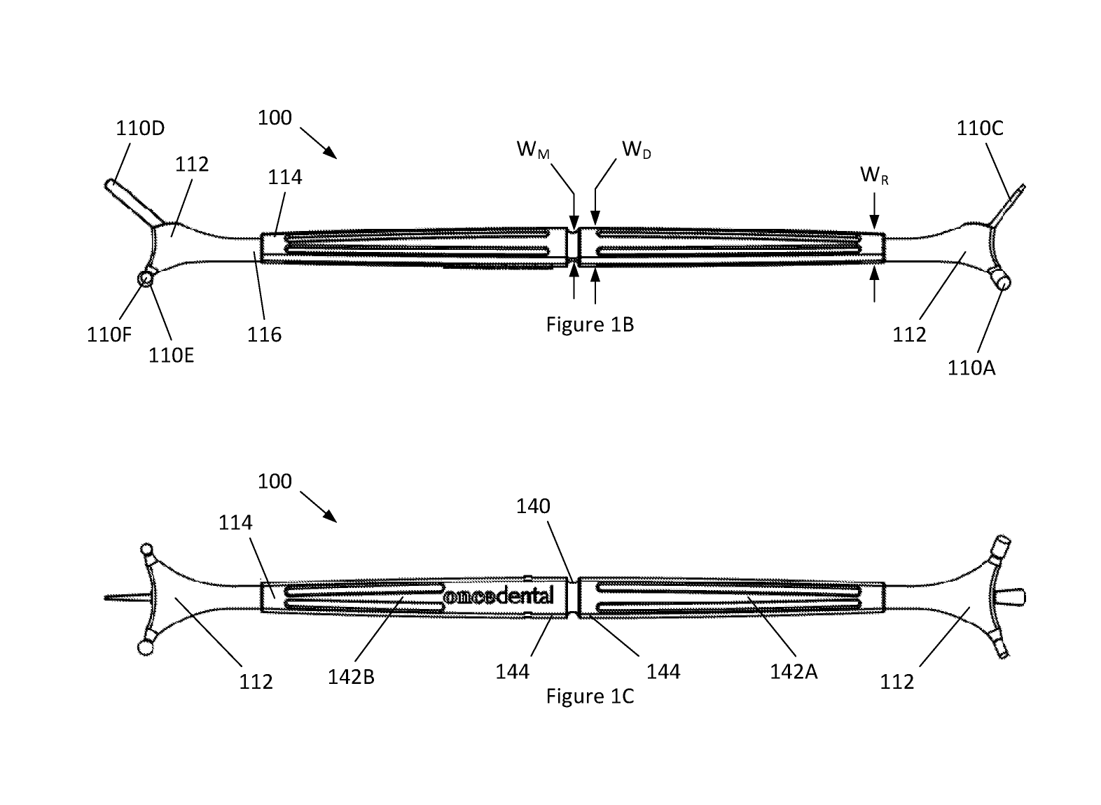

FIGS. 1A, 1B and 1C illustrate a multi-functional dental instrument 100 according to the present invention. The dental instrument 100 has an elongate handle 102 connecting between multi-sectioned tool heads 104A and 104AB at opposite ends of the handle.

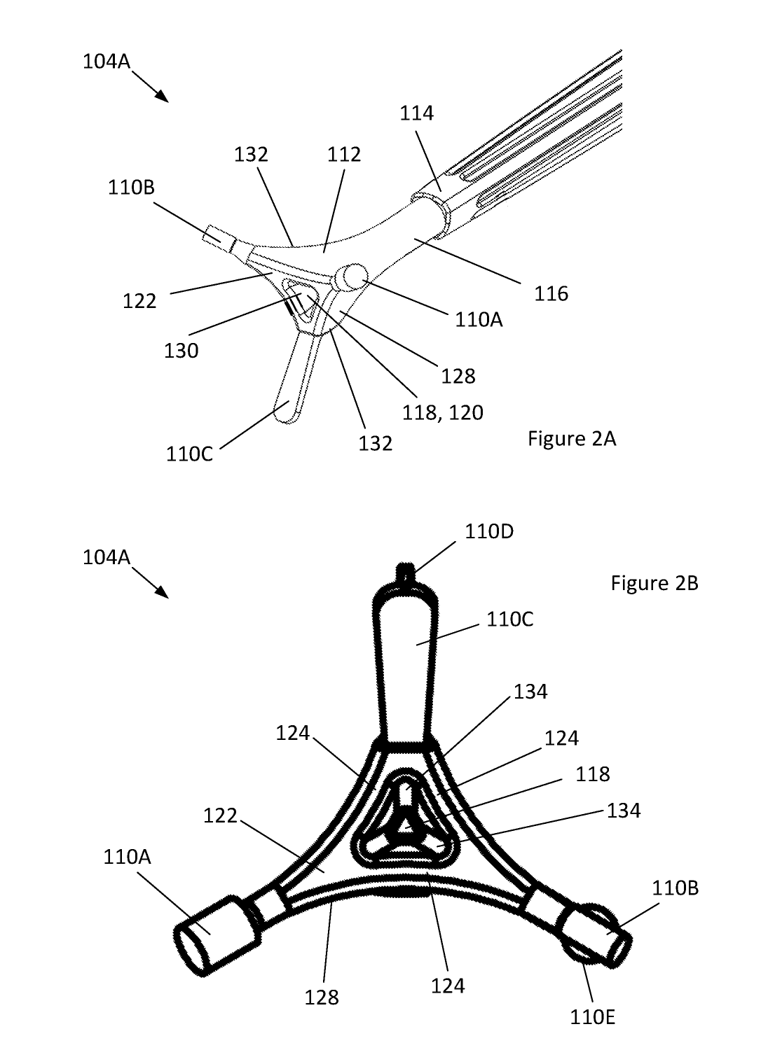

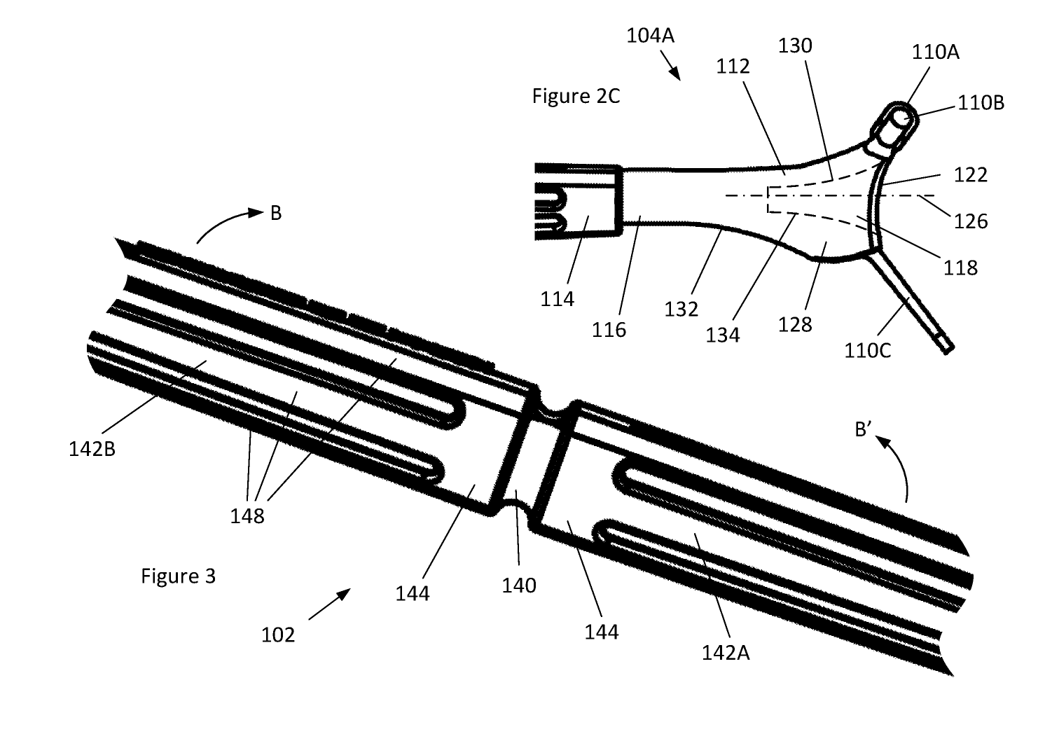

The tool heads 104A and 104B are similar in design, and FIGS. 2A, 2B and 2C illustrate one tool head 104A in more detail. The tool heads 104A and 104B each comprise three projecting tools 110A to 110F. The tools are a large cylindrical plugger 110A, a small cylindrical plugger 110B, a large flat blade 110C, a small flat blade 110D, a large ball-like burnisher 110E and a small ball-like burnisher 110F.

Each of the tool heads 104A and 104B comprises a flared, end section 112 connected to an end 114 of the handle 102 by a stem 116. The width of the flared hollow end section 112 increases away from the handle 102.

The flared end section 112 is hollow, being provided with a cavity 118 that has an opening 120 at the end 122 remote from the handle 102. The width of the cavity 118 increases away from the handle 102. The cavity 118 is formed between side walls 124, which increase in width away from the handle 102. The cavity 118 has an axis 126, and in a cross-section perpendicular to that cavity axis, the exterior surfaces 128 of the side walls 124 are concave and the interior surfaces 130 are convex (i.e. each of the surfaces of the wall sections is bowed in towards the axis at the middle, and curves away from the axis towards the respective edges 132 and 134). Accordingly, perpendicular to the axis 126, the flared, hollow end section 112 is generally triangular, with side walls that bow in towards the centre of the triangle (like a curved three-pointed star).

The end 122 of the flared, hollow end section 112 is concavely curved, extending further, axially along the direction away from the handle 102 with increasing separation from the axis 126 (i.e. the end 122 comprises a concave generally triangular surface).

Alternatively, the side walls may each be provided with one or more apertures, to reduce the manufacturing volume, and to facilitate rinsing of the tool head during use. For example the flared hollow end section may be basket-like through the provision of an array of apertures in each of the side walls.

Advantageously, the provision of the cavity within the flared, hollow end section enhances the strength of the tool head, with a reduced material volume, and is inexpensive to manufacture. Further, the bowed-in side walls provide further enhancement of the strength of the tool head. Yet further, the concave end face of the flared, hollow end section provides further enhancement of the strength of the tool head.

The figures illustrate a dental instrument having three tools projecting from each tool head, equally distributed around the common axis of the cavity and handle. However, in alternative designs, each flared tool head may have two, four or a greater number of projecting tools. In alternative designs having more than two tools in a single tool head, the bowed-in side walls have a cross-section that is of a corresponding, generally polygonal shape (i.e. a tool head with four tools has a bowed-in square cross-section). In the case of a tool head having two projecting tools, the end section may bow outwards, having a cross-section that is oval.

The elongate handle 102 of the dental instrument 100 illustrated in FIGS. 1A to 1C has a central waist portion 140 that is less resistant to deformation by bending and/or snapping than the adjacent handle sections 142A and 142B between which the waist portion connects, when contra-rotational torques B and B′ about torque axes transverse (e.g. substantially perpendicular) to the length of the handle are applied to the handle sections, as is illustrated in FIG. 3.

The waist portion 140 of the handle 102 comprises a narrow section with a generally triangular negative curvature surface (i.e. concave with respect to the length of the handle 102) with a minimum width W_{M} that is narrower than the width W_{P} of the proximal ends 144 of the adjacent handle sections 142A and 142B.

The adjacent handle sections 142A and 142B are generally triangular in cross-section, and provided with an arrangement of ribs 148 running along the length of each handle section. The triangular section of the handle sections 142A and 142B, and the provision of the ribs 148 enhances the strength of the handle sections against bending 142.

The handle sections 142A and 142B are each tapered such that they reduce in width away from the waist portion 140. Accordingly, the width W_{P} of the ends 114 of the handle sections 142A and 142B proximate the waist portion 140 is greater than the width W_{R} of the ends 114 of the handle sections remote from the waist portion. Such tapering reduces the material volume of the dental instrument 100, as well as being more comfortable for a patient and increasing visibility for the dentist.

After use, the dental instrument 100 may be bent or snapped at its waist portion 140. This serves clearly to indicate that the dental instrument has been used, and to deter or prevent re-use, thereby reducing the risk of cross-contamination between patients. Further, such bending or snapping may enable a collection of waste dental instruments to be more efficiently stored in a biohazardous waste bin. Further, it enables the dental instrument to be inserted into a smaller reception mechanism of a biohazardous waste bin or biohazardous waste shredder.

In the illustrated embodiment, the waist portion 140 in the handle 102 of the dental instrument 100 is approximately half-way along the length of the handle (i.e. connects between handle sections 142A and 142B of substantially equal length), which is also approximately half-way along the length of the dental instrument.

Alternatively, the waist portion may be located away from the mid-point of the length of the handle, with adjacent handle sections of sufficient length that they may each be grasped by a user, to enable deformation by bending of snapping of the waist portion by the application of contra-rotational torques. The waist portion may be within the central half, third or quarter of the length of the handle.

The waist portion may have a cylindrical shape, an alternative polygonal cross-section, or may have an hour-glass shape, or that of two conic frustums abutting at their narrow ends. Alternatively, the waist portion may have a negative-curvature surface of revolution about the length of the handle (i.e. a surface with cylindrical rotational symmetry that is bowed-in towards the rotational symmetry axis intermediate the ends).

In the illustrated embodiment, the dental instrument is formed from a plastics material, such as a polycarbonate material. The dental instrument may be formed by an injection moulding process. The dental instrument may be formed from a material that is suitable for deforming by bending or snapping at a waist portion of the handle. The dental instrument may be formed from a material that is suitable for shredding.

Alternatively, the dental instrument may designed for re-use, following thorough cleaning, being formed from a metal material, such as stainless steel or aluminium.

The figures provided herein are schematic and not to scale.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A dental instrument for hand use comprising a handle and a tool head, the tool head has a plurality of tools projecting from a flared end section having a width that increases away from the handle.

2. A dental instrument according to claim 1, wherein the flared end section has edges that increase in separation supra-linearly with increasing distance from the handle.

3. A dental instrument according to claim 1, wherein the cross-section of the flared end section has side walls with concave exterior surfaces.

4. A dental instrument according to claim 1, wherein the exterior cross-section of the flared end section is generally polygonal.

5. A dental instrument according to claim 1, wherein the exterior cross-section of the flared end section is generally triangular.

6. A dental instrument according to claim 1, wherein the flared end section is hollow, having an internal cavity.

7. A dental instrument according to claim 6, wherein the cavity is open-ended, having an opening at an opposite end from the handle.

8. A dental instrument according to claim 6, wherein the width of the cavity increases away from the handle.

9. A dental instrument according to claim 6, wherein the side walls of the flared end section comprise one or more apertures into the internal cavity.

10. A dental instrument according to claim 6, wherein the cross-section of the flared end section has side walls with convex interior surfaces.

11. A dental instrument according to claim 1, comprising an elongate handle having a waist portion connecting between adjacent handle sections, wherein the waist portion is less resistant to deformation by bending and/or snapping than the adjacent handle sections between which the waist portion connects, when contra-rotational torques about torque axes transverse to the length of the handle are applied to the handle sections.

12. A dental instrument according to claim 11, wherein the waist portion has a narrower minimum width than the minimum width of proximal ends of the adjacent handle sections.

13. A dental instrument according to claim 11, wherein the waist portion is within the central half of the length of the handle.

14. A dental instrument according to claim 11, wherein the waist portion is within a portion of the handle selected from the group consisting of the central third of the length of the handle and the central quarter of the length of the handle.

15. (canceled)

16. A dental instrument according to claim 11, wherein the adjacent handle sections taper such that their ends remote from the waist portion are narrower than their ends proximate the waist portion.

17. A dental instrument according to claim 11, wherein the adjacent handle sections have a generally triangular cross-sectional shape.

18. A dental instrument according to claim 11, wherein the adjacent handle sections are provided with a plurality of ribs running along their length.

19. A dental instrument according to claim 1, comprising a tool head at each end of the handle.

20. A dental instrument according to claim 1 formed from a material selected from the group consisting of a plastics material and a metal material.

21. A dental instrument according to claim 1 formed from a material suitable for shredding.

22-23. (canceled)
